(19) United States
(12) Patent Application Publication
(10) Pub. No.: US 2018/0223917 A1
(43) Pub. Date: Aug. 9, 2018

(54) AUTOMATIC CLUTCH DEVICE

(71) Applicant: NTN CORPORATION, Osaka (JP)

(72) Inventors: Takahide SAITO, Shizuoka (JP); Kimihito USHIDA, Shizuoka (JP); Koji SATO, Shizuoka (JP); Masahiro KAWAI, Shizuoka (JP); Atsushi IKEDA, Shizuoka (JP)

(73) Assignee: NTN CORPORATION, Osaka (JP)

(21) Appl. No.: 15/751,711

(22) PCT Filed: Aug. 2, 2016
(86) PCT No.: PCT/JP2016/072602

§ 371 Date: Feb. 9, 2018

(30) Foreign Application Priority Data
Aug. 10, 2015 (JP) 2015-158192

(51) Int. Cl. F16D 23/12; F16D 28/00; F16H 25/12; F16H 25/20; F16D 13/40

(52) U.S. Cl. CPC F16D 23/12; F16D 28/00; F16D 2023/123; F16H 25/20; F16D 13/40; F16H 25/12

(57) ABSTRACT

An automatic clutch device includes an axial force generating mechanism which presses and moves a release bearing toward a diaphragm spring to disengage a clutch disk and the diaphragm spring from each other. The axial force generating mechanism includes an electric motor disposed adjacent to the outer periphery of an end of an input shaft of a transmission, and a rotation-linear motion conversion mechanism for converting the rotation of the rotor of the electric motor to a linear motion of the release bearing. This automatic clutch device is compact in size and sufficiently responsive.

### TECHNICAL FIELD

The present invention relates to an automatic clutch device for selectively transmitting and not transmitting the power from an engine crankshaft to the input shaft of the transmission.

### BACKGROUND ART

The below-identified Patent Documents 1 and 2 disclose known automatic clutch devices for automatically engaging and disengaging manual transmissions (MT) and automated manual transmissions (AMT).

The automatic clutch device disclosed in Patent Document 1 is configured such that when the clutch pedal is depressed, hydraulic pressure is generated in a master cylinder mechanically connected to the clutch pedal, and is supplied to a clutch release cylinder, the clutch release cylinder pivots a release fork, thereby pressing a release bearing, a pressure plate is pressed against a flywheel under the pressing force applied to the pressure plate from the release bearing, and the clutch device engages.

The automatic clutch device disclosed in Patent Document 2 is configured, similar to the clutch device of Patent Document 1, such that hydraulic pressure generated in the master cylinder by depressing the clutch pedal is supplied to a clutch release cylinder, the clutch release cylinder pivots a release fork, the release fork presses a release bearing, and the clutch device disengages.

### PRIOR ART DOCUMENTS

### Patent Documents

### Patent Document 1: JP Patent Publication 2010-78156A

### Patent Document 2: JP Patent Publication 2014-202238A

### SUMMARY OF THE INVENTION

### Object of the Invention

Since the clutch device of either of Patent Documents 1 and 2 is configured to be engaged and disengaged by pivoting the release fork with the clutch release cylinder, such clutch devices tend to be large in size. Moreover, since such clutch devices require a hydraulic pump, and pipe connections between the hydraulic pump and the clutch release cylinder, a large installation space is needed for such clutch devices.

While the ambient temperature is low, hydraulic pressure used to activate the clutch release cylinder flows less smoothly in the pipes due to elevated viscosity of the hydraulic oil, thus deteriorating response time of the clutch release cylinder.

An object of the present invention is to reduce the size, and improve responsiveness, of an automatic clutch device of the type that selectively transmits power from the engine to the input shaft of the transmission by applying a pushing force to the release bearing.

### Means for Achieving the Object

In order to achieve this object, the present invention provides an automatic clutch device comprising a flywheel attached to an end of a crankshaft of an engine; a clutch disk provided at an end of an input shaft of a transmission, and opposed to the flywheel; a pressure plate configured to bias the clutch disk toward the flywheel; a release bearing configured to be movable toward and away from the pressure plate; and an axial force generating mechanism configured to press and move the release bearing toward the pressure plate, the automatic clutch device being configured such that when the pressure plate is pressed by the release bearing, the clutch disk and the pressure plate are disengaged from each other, wherein the axial force generating mechanism comprises: an electric motor disposed adjacent to an outer periphery of the end of the input shaft, and having a rotor; and a rotation-linear motion conversion mechanism configured to convert rotation of the rotor of the electric motor to a linear motion of the release bearing.

With this automatic clutch device, while the electric motor is off, the clutch disk is pressed against the flywheel under the biasing force of the pressure plate, and the clutch is engagement, so that the rotation of the engine crankshaft is transmitted to the input shaft of the transmission.

When the electric motor is activated, the rotation of the rotor of the electric motor is converted to a linear motion of the output member by the rotation-linear motion conversion mechanism. That is, the output member moves in the axial direction, thus pressing the release bearing. This moves the release bearing in the axial direction, thus pressing and elastically deforming the pressure plate until the clutch disk is not pressed by the pressure plate, and thus, the flywheel is not pressed by the clutch disk, i.e., until the clutch disengages. With the clutch disengaged, power is not transmitted from the crankshaft to the input shaft.

Thus, by turning on and off the electric motor, the clutch is selectively engaged and disengaged so that the power from the crankshaft can be selectively transmitted and not transmitted to the input shaft.

Since the electric motor and the rotation-linear motion conversion mechanism for converting the rotation of the rotor of the electric motor to a linear motion of the output member on the input shaft are arranged around the input shaft, the automatic clutch device according to the present invention is compact in size. Since the power source of this clutch device is an electric motor, the clutch device can be easily mounted in position simply by properly arranging wires, and does not require a large installation space.

Since an electric motor can be quickly controlled without being influenced by changes in the surrounding environment such as a change in temperature, the automatic clutch device according to the present invention is sufficiently responsive.

The electric motor of the automatic clutch device according to the present invention may be a hollow motor having a tubular rotor, or may be one whose rotor is a solid shaft. If a hollow motor is used, since the rotation-linear motion conversion mechanism can be directly driven by the hollow motor by fitting the hollow motor onto the input shaft, it is possible to further reduce the size of the automatic clutch device.

If an electric motor having a solid shaft/rotor is used, the electric motor may be arranged to extend perpendicular to the input shaft, or parallel to the input shaft. If the electric motor is arranged to extend perpendicular to the input shaft, a rotation transmission mechanism comprising a worm and a worm wheel is provided between the rotor of the electric motor and the rotation-linear motion conversion mechanism to transmit the rotation of the rotor of the electric motor to the rotation-linear motion conversion mechanism through the rotation transmission mechanism.

If the electric motor is arranged to extend parallel to the input shaft, a rotation transmission mechanism comprising a pair of spur gears meshing with each other is provided between the rotor of the electric motor and the rotation-linear motion conversion mechanism to transmit the rotation of the rotor of the electric motor to the rotation-linear motion conversion mechanism through the rotation transmission mechanism.

The rotation-linear motion conversion mechanism for converting the rotation of the rotor of the electric motor to a linear motion of the output member may have any of the below structures a)-c):

Structure a): including a plurality of tubes having different diameters from each other, and slidably fitted one in another such that the plurality of tubes form a telescopic tube assembly, wherein a first one of each radially adjacent pair of the tubes is formed with an inclined cam groove, and a second one of the radially adjacent pair of tubes has a pin inserted in the cam groove, and wherein one of the plurality of tubes which is the largest in diameter is an input member configured such that the rotation of the rotor of the electric motor is transmitted to the input member, and one of the plurality of tubes which is the smallest in diameter is an output member that is non-rotatably and slidably supported by a support member supporting the release bearing, and configured to press the release bearing.

Structure b): including a plurality of annular cam plates that are arranged in juxtaposition to each other in an axial direction, wherein a cam mechanism is provided between each adjacent pair of the plurality of cam plates, and configured to convert relative rotation between the adjacent pair of cam plates to relative axial linear motion therebetween, and wherein a first one of the plurality of cam plates remotest from the release bearing is an input member configured such that the rotation of the rotor of the electric motor is transmitted to the input member, and a second one of the plurality of cam plates closest to the release bearing is an output member that is non-rotatably and slidably supported by a support member supporting the release bearing, and configured to press the release bearing.

Structure c): including a tubular nut member having an inner periphery formed with an internal thread, and a tubular, externally threaded member in threaded engagement with the internal thread of the nut member, and wherein the nut member is an input member configured such that the rotation of the rotor of the electric motor is transmitted to the input member, and the externally threaded member is an output member that is non-rotatably and slidably supported by a support member supporting the release bearing, and configured to press the release bearing.

Each cam mechanism of the rotation-linear motion conversion mechanism having Structure b) may be a ball cam comprising opposed pairs of cam grooves, and balls each received between a corresponding opposed pair of cam groove, or a face cam comprising V-shaped cam grooves and V-shaped cam protrusions.

### Advantages of the Invention

According to the present invention, as described above, since the rotation of the electric motor is converted to a linear motion of the output member by the rotation-linear motion conversion mechanism to axially move the release bearing, thereby pressing the pressure plate, compared to a conventional automatic clutch device in which the release fork is pivoted by the clutch release cylinder to move the release bearing toward the pressure plate, the automatic clutch device according to the present invention is compact in size, and does not require a large installation space.

Since the electric motor as the driving source is activated and deactivated by operating a switch, and its operation is not influenced by changes in the surrounding environment such as a change in temperature, the automatic clutch device according to the present invention is sufficiently responsive.

### BRIEF DESCRIPTION OF THE DRAWINGS

FIG. 1 is a sectional view of an automatic clutch device embodying the present invention.

FIG. 2 shows, in enlarged section, a release bearing of FIG. 1.

FIG. 3 is a sectional view taken along line III-III of FIG. 2.

FIG. 4A shows in section how an electric motor is arranged in a different manner.

FIG. 4B shows in section how the electric motor is arranged in a still different manner.

FIG. 5 shows in section a different rotation-linear motion conversion mechanism.

FIG. 6 shows in enlarged section the rotation-linear motion conversion mechanism and release bearing of FIG. 5.

FIG. 7 is a sectional view taken along line VII-VII of FIG. 6.

FIG. 8 is a cross-sectional view showing a portion of a largest-diameter tube of FIG. 6 in outer appearance.

FIG. 9 shows in section the rotation-linear motion conversion mechanism shown in FIG. 5 in an operational state.

FIG. 10 is an exploded perspective view of the rotation-linear motion conversion mechanism shown in FIG. 5.

FIG. 11 shows in vertical section a still different rotation-linear motion conversion mechanism.

FIG. 12 is a sectional view taken along line XII-XII of FIG. 11.

FIG. 13A is a sectional view taken along line XIII-XIII of FIG. 12.

FIG. 13B shows in section an operational state.

FIG. 14 is a sectional view taken along line XIV-XIV of FIG. 11.

FIG. 15 is a sectional view taken along line XV-XV of FIG. 11.

FIG. 16 shows in section a still different rotation-linear motion conversion mechanism.

### BEST MODE FOR EMBODYING THE INVENTION

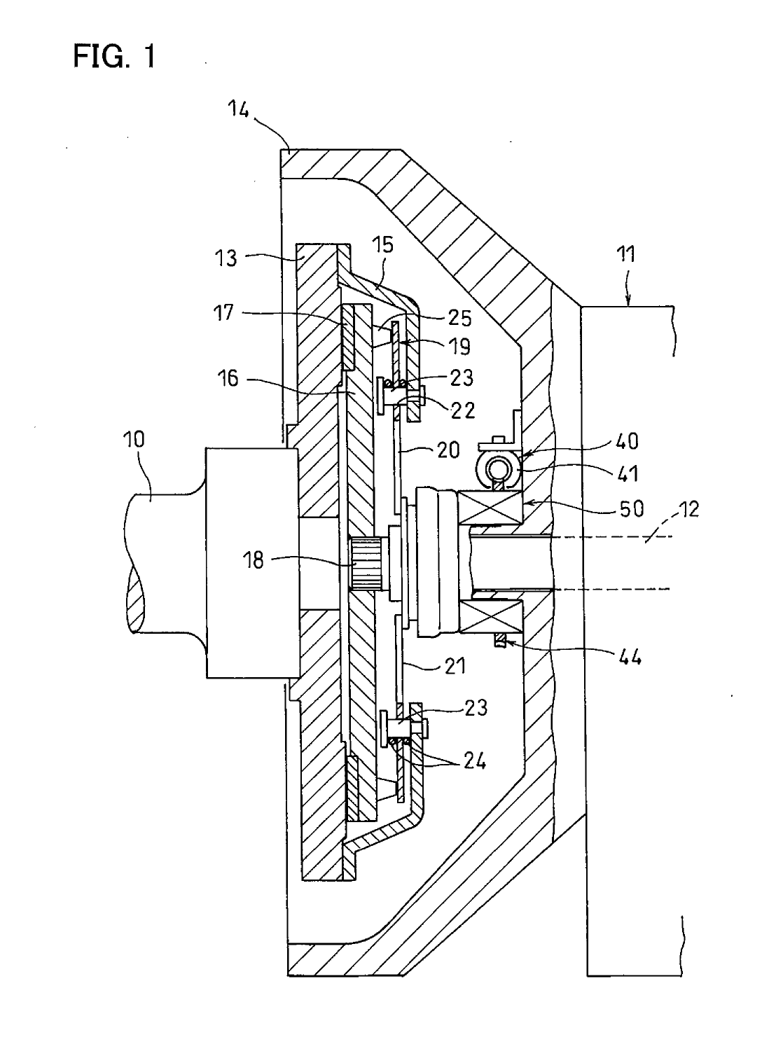

The embodiment of the present invention is now described with reference to the drawings. FIG. 1 shows an input shaft 12 of a transmission 11 including gears mounted on parallel shafts, the input shaft 12 being arranged coaxial with a crankshaft 10 of an engine.

A flywheel 13 is fixed to the end of the crankshaft 1 opposed to the input shaft 12, and is located inside of, so as to be rotatable relative to, a clutch housing 14 of the transmission 11.

A clutch cover 15 is mounted to the outer peripheral portion of the outer side surface of the flywheel 13 that is opposed to the transmission 11. A clutch disk 16 is mounted in the clutch cover 15.

A facing 17 is fixed to the outer peripheral portion of the outer side surface of the clutch disk 16 that is opposed to the flywheel 13. The clutch disk 16 is fitted to serrations 18 formed on the outer periphery of the end of the input shaft 12 so as to be rotationally fixed and axially slidable, relative to the input shaft 12.

A pressure plate 19 is mounted inside of the clutch cover 15. The pressure plate 19 comprises a diaphragm spring. The diaphragm spring 19 is an annular member formed with radially extending slots 20 at its inner peripheral portion, and includes a spring piece 21 formed between each adjacent pair of the slots 20.

The diaphragm spring 19 further includes circumferentially equidistantly spaced apart pin holes 22 at its portion between the circle passing through the closed ends of the slots 20 and the radially outer surface of the diaphragm spring 19. Support pins 23 are mounted to the clutch cover 15, and each loosely inserted in one of the pin holes 22.

A pair of rings 24 are wrapped around the support pins 23 on the respective sides of the diaphragm spring 19 such that the diaphragm spring 19 is supported by the pair of rings 24 and the support pins 23.

The diaphragm spring 19 presses protrusions 25 on the outer peripheral portion of the clutch disk 16 toward the flywheel 13, thereby pressing the facing 17 against the flywheel 13. When the inner peripheral portion of the diaphragm spring 19 is pressed toward the flywheel 13, the facing 17 is no longer pressed against the flywheel 13, that is, the clutch disengages.

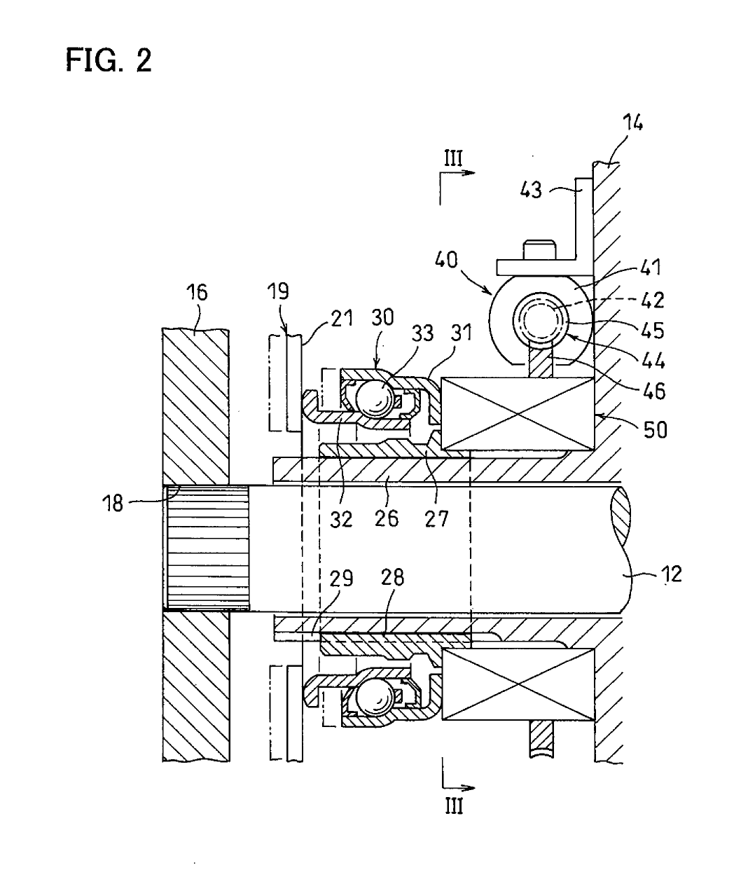

As shown in FIG. 2, the clutch housing 14 includes a guide tube 26 covering the input shaft 12. A sleeve 27 is fitted on the guide tube 26. The sleeve 27 has, on the inner periphery thereof, keys 28 fitted in key grooves 29 formed in the outer periphery of the guide tube 26 so that the sleeve 27 is non-rotatably but slidably supported by the guide tube 26.

A release bearing 30 surrounds the sleeve 27. The release bearing 30 includes an outer race 31, an inner race 32, and balls 33. The inner race 32 is connected to the inner peripheral portion of the diaphragm spring 19.

The outer race 31 is pressed toward the diaphragm spring 19 by an axial force generating mechanism 40 surrounding the guide tube 26.

The axial force generating mechanism 40 includes an electric motor 41, and a rotation-linear motion conversion mechanism 50 configured to convert the rotation of the rotor 42 of the electric motor 41 to a linear motion of the release bearing 30.

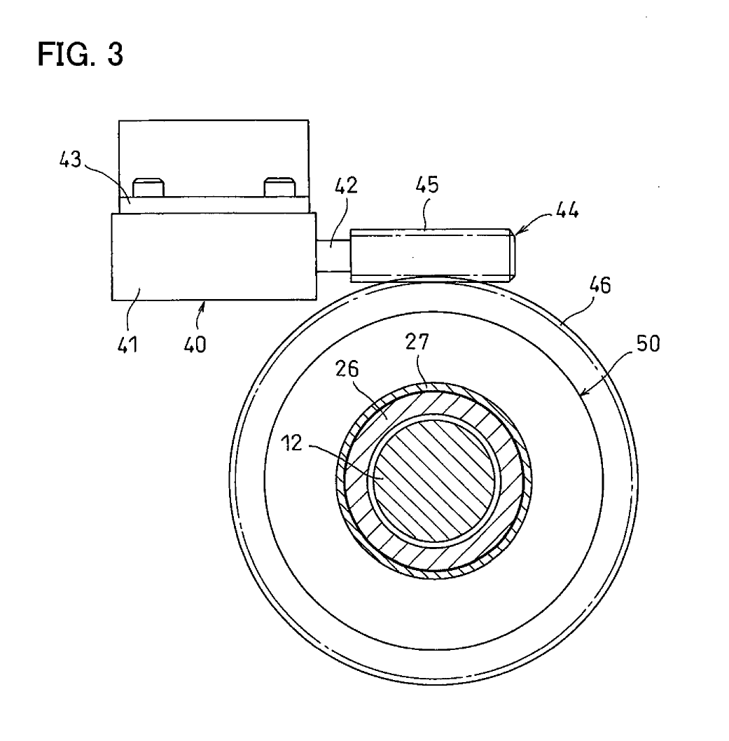

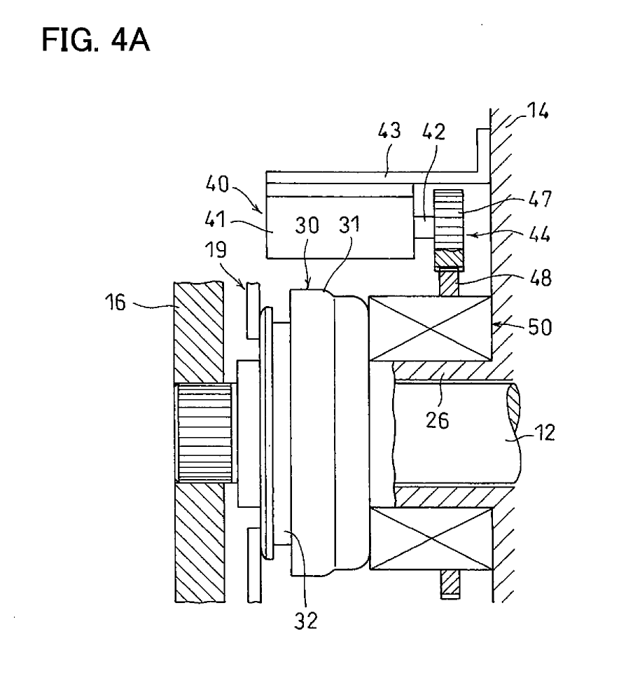

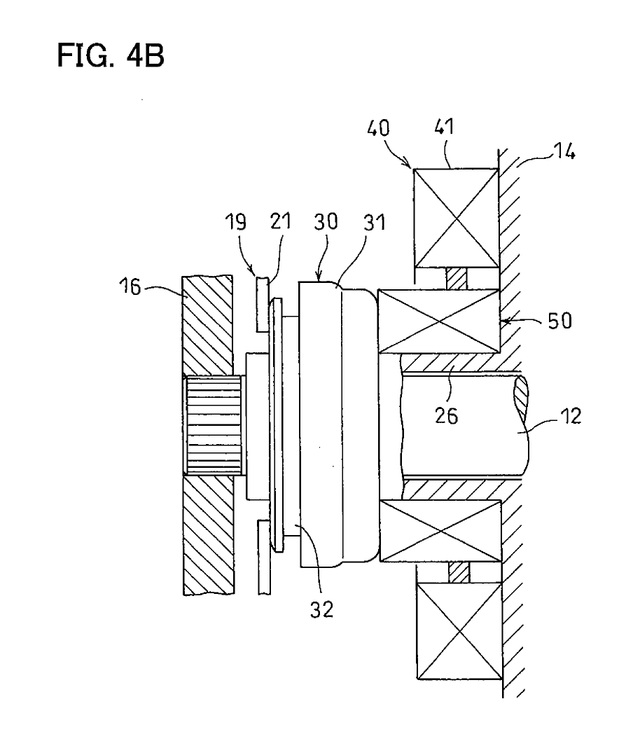

The rotor 42 of the electric motor 41 may be, as shown in FIGS. 3 and 4A, a solid shaft, or the electric motor 41 may be, as shown in FIG. 4B, a hollow motor including an unillustrated tubular rotor.

If a solid shaft is used as the rotor 42 of the electric motor 41, the electric motor 41 may be arranged to extend perpendicular to the input shaft 12 as shown in FIGS. 2 and 3, or parallel to the input shaft 12 as shown in FIG. 4A.

In FIGS. 2 and 3, the electric motor 41 is supported by a bracket 43 mounted to the clutch housing 14, and the rotation of the rotor 42 of the electric motor 41 is transmitted to the rotation-linear motion conversion mechanism 50 through a rotation transmission mechanism 44 comprising a worm 45 and a worm wheel 46.

In FIG. 4A, the electric motor 41 is supported by a bracket 43 mounted to the clutch housing 14, and the rotation of the rotor 42 of the electric motor 41 is transmitted to the rotation-linear motion conversion mechanism 50 through a rotation transmission mechanism 44 comprising a pair of spur gears 47 and 48 meshing with each other.

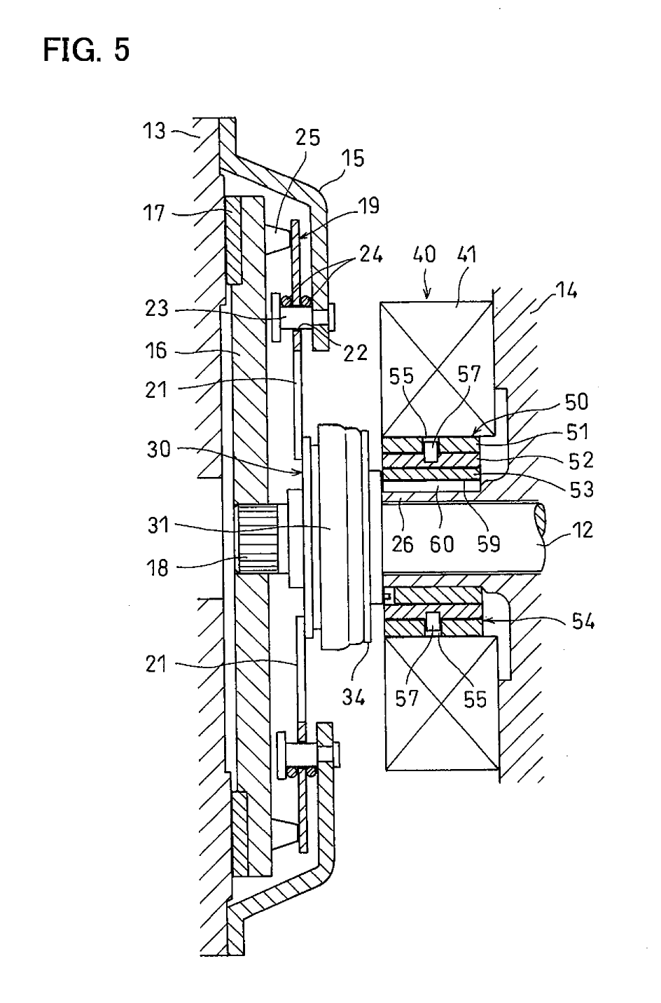

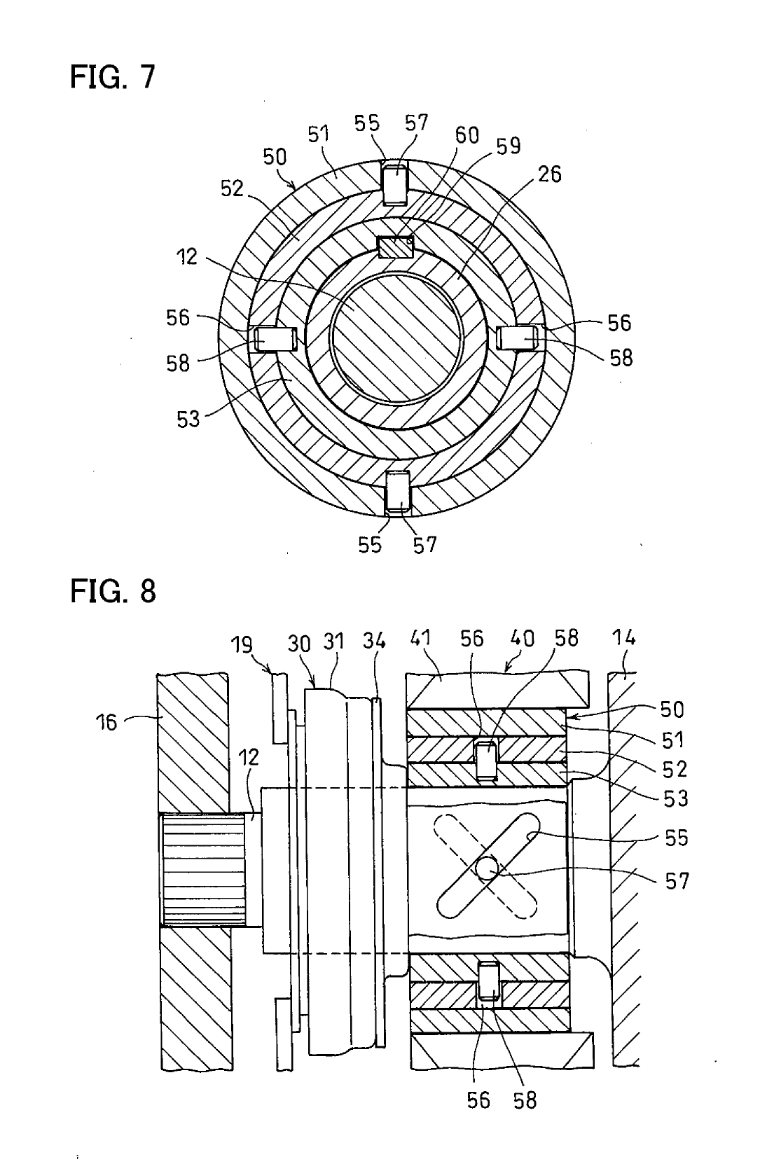

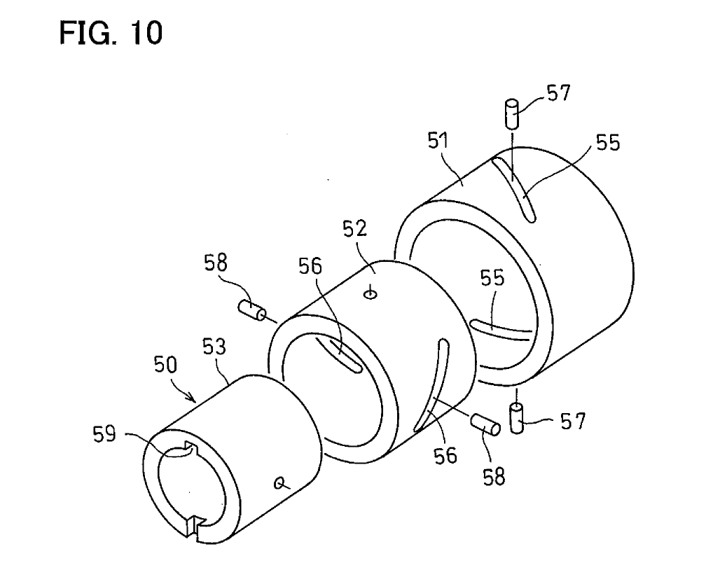

If the hollow motor 41 shown in FIG. 4B is used, the hollow motor 41 is supported by the clutch housing 14, and the rotation of the unillustrated rotor is directly transmitted to the rotation-linear motion conversion mechanism 50. FIGS. 5-10 show an exemplary rotation-linear motion conversion mechanism 50 for converting the rotation of the rotor of the hollow motor 41 to a linear motion of the release bearing 30.

The rotation-linear motion conversion mechanism 50 shown in FIGS. 5-10 comprises a telescopic tube assembly 54 which is an assembly of a plurality of tubes having different diameters from each other, the plurality of tubes being constituted by an outer tube 51, an intermediate tube 52, and an inner tube 53 that are slidably fitted one in another. The intermediate tube 52 includes pins 57 slidably inserted in respective oblique cam grooves 55 formed in the outer tube 51, while the inner tube 53 includes pins 58 slidably inserted in respective oblique cam grooves 56 formed in the intermediate tube 52. The guide tube 26, as a support member, supports the inner tube 53 such that the inner tube 53 is not rotatable but slidable relative to the guide tube 26.

This rotation-linear motion conversion mechanism 50 is configured such that when its input member, i.e., the outer tube 51 is directly rotationally driven by the hollow motor 41, the intermediate tube 52 moves axially while rotating due to the specific relationship between the cam grooves 55 of the outer tube 51 and the pins 57 of the intermediate tube 52, and the inner tube 53, as the output member, moves axially while rotating due to the specific relationship between the cam grooves 56 of the intermediate tube 52 and the pins 58 of the inner tube 53, thereby pressing the outer race 31 of the release bearing 30.

In the embodiment, the three tubes, i.e., the outer tube 51, intermediate tube 52, and inner tube 32 constitute the telescopic tube assembly 54. However, the number of tubes that constitute the telescopic tube assembly 54 is not limited to three, provided it is more than one.

In the embodiment, in order to prevent rotation, but allow sliding movement, of the inner tube 53 relative to the guide tube 26, keys 60 mounted to the guide tube 26 are slidably fitted in key grooves 59 formed in the radially inner surface of the inner tube. However, for the same purpose, the inner tube 53 may be connected to the guide tube 26 in a different manner, for example, through serrations or splines.

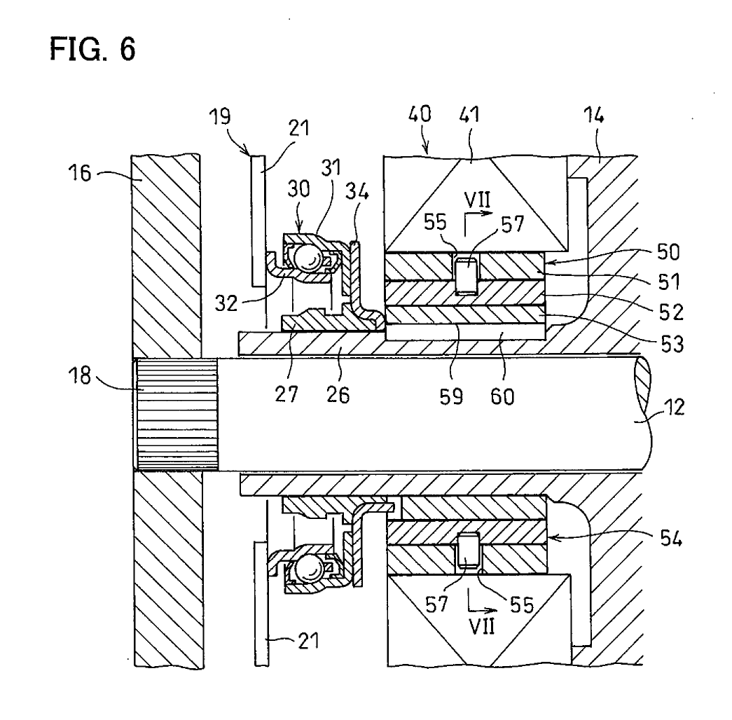

The inner tube 53 of the rotation-linear motion conversion mechanism 50 axially presses (biases) the outer race 31 of the release bearing 30 by pressing a coupling plate 34 coupling, as shown in FIG. 6, the outer race 31 to the sleeve 27 so that the outer race 31 is not rotatable.

FIG. 5 shows the state in which the telescopic tube assembly 54, which constitutes the rotation-linear motion conversion mechanism 50, is contracted. In this state, the clutch disk 16 is pressed against the flywheel 13 by the diaphragm spring 19, that is, the clutch is engaged, so that the rotation of the crankshaft 10, shown in FIG. 1, is transmitted to the input shaft 12.

In the state shown in FIG. 5, when the outer tube 51 of the rotation-linear motion conversion mechanism 50 is rotated by driving the hollow motor 41, since, as shown in FIGS. 6 and 8, the pins 57 of the intermediate tube 52 are inserted in the cam grooves 55 of the outer tube 51, the intermediate tube 52 moves axially while rotating. Since the pins 58 of the inner tube 53 are inserted in the cam grooves 56 of the intermediate tube 52, the rotation of the intermediate tube 52 causes the inner tube 53 to be moved axially. The telescopic tube assembly 54 is thus extended.

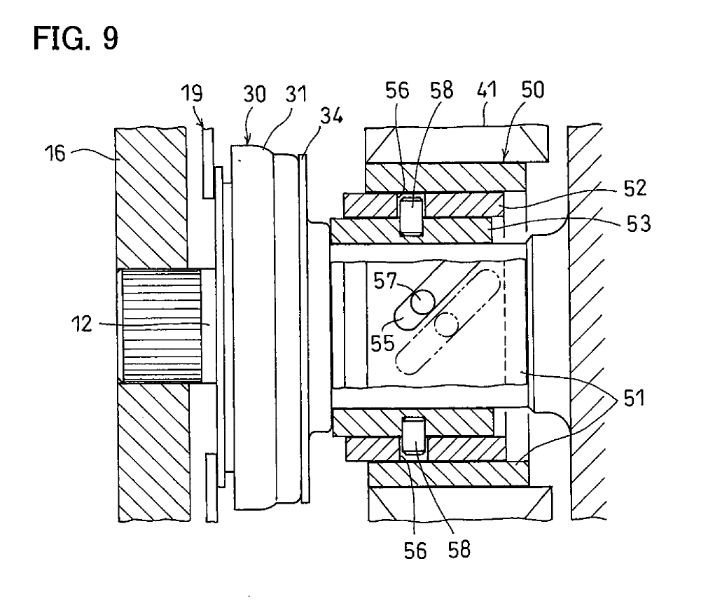

FIG. 9 shows the state in which the telescopic tube assembly 54 is extended. When the telescopic tube assembly 54 is extended, the release bearing 30 is pushed and moved axially by the tube assembly 54, and the inner peripheral portion of the diaphragm spring 19 is pressed by the release bearing 30, until the diaphragm spring 19 is moved to a position where the clutch disk 16 is not pressed by the diaphragm spring 19, that is, the clutch disengages, so that power is not transmitted from the crankshaft 10, shown in FIG. 1, to the input shaft 12.

In the embodiment of FIG. 5, since the rotation-linear motion conversion mechanism 50 comprising the telescopic tube assembly 54 converts the rotation of the hollow motor 41 to a linear motion of the release bearing 30 to selectively press, and not press, the clutch disk 16 against the flywheel 13, i.e., selectively engage and disengage the clutch, these elements constitute a compact automatic clutch device. Since its power source is a hollow electric motor 41, the clutch device can be easily mounted in position simply by properly arranging wires, and does not require a large installation space.

Instead of a hollow electric motor 41 as shown in FIG. 5, an electric motor 41 whose rotor 42 is a solid shaft as shown in FIGS. 2, 3 and 4A may be used. In this case, the rotation of the rotor 42 of the electric motor 41 is transmitted to the outer tube 51 through the rotation transmission mechanism 44 shown in FIGS. 2 and 3, which comprises the worm 45 and the worm wheel 46, or the rotation transmission mechanism shown in FIG. 4A, i.e., the one comprising the spur gears 47 and 48.

When a hollow motor is used as the electric motor 41 as shown in FIG. 5, the rotation-linear motion conversion mechanism 50 comprising the telescopic tube assembly 54 can be mounted in the hollow space of the hollow motor, so that the automatic clutch device can be made extremely compact.

While in the embodiment of FIG. 5, the rotation-linear motion conversion mechanism 50 is a telescopic tube assembly 54 comprising a plurality of tubes having different diameters from each other and slidably fitted one in another, the rotation-linear motion conversion mechanism 50 is not limited thereto.

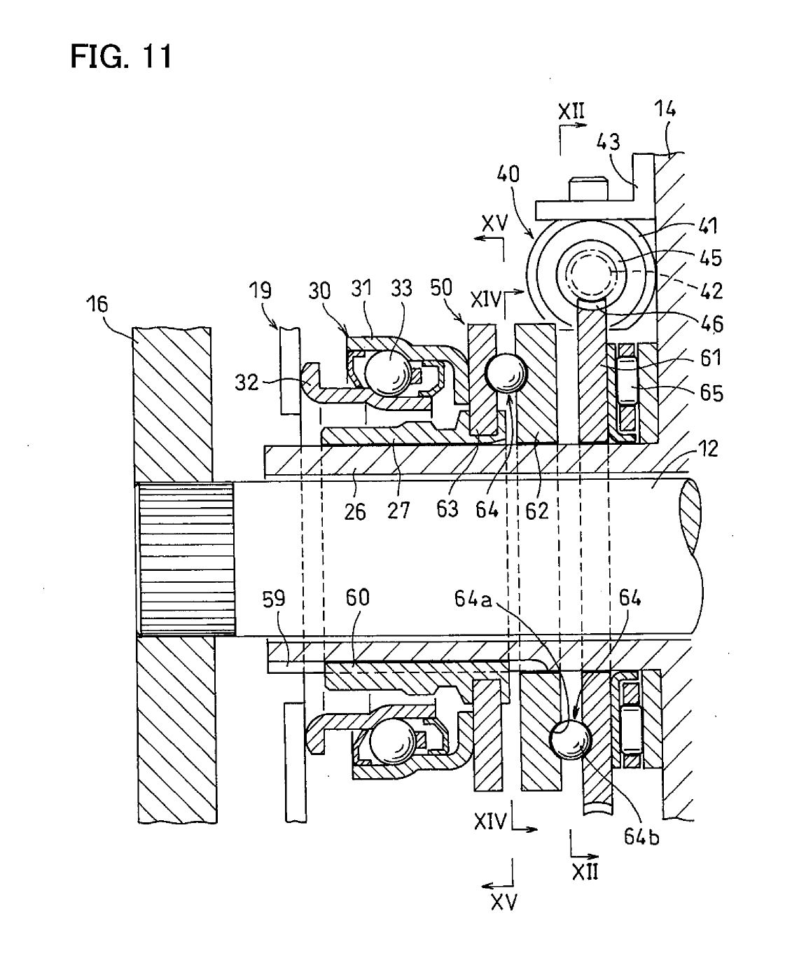

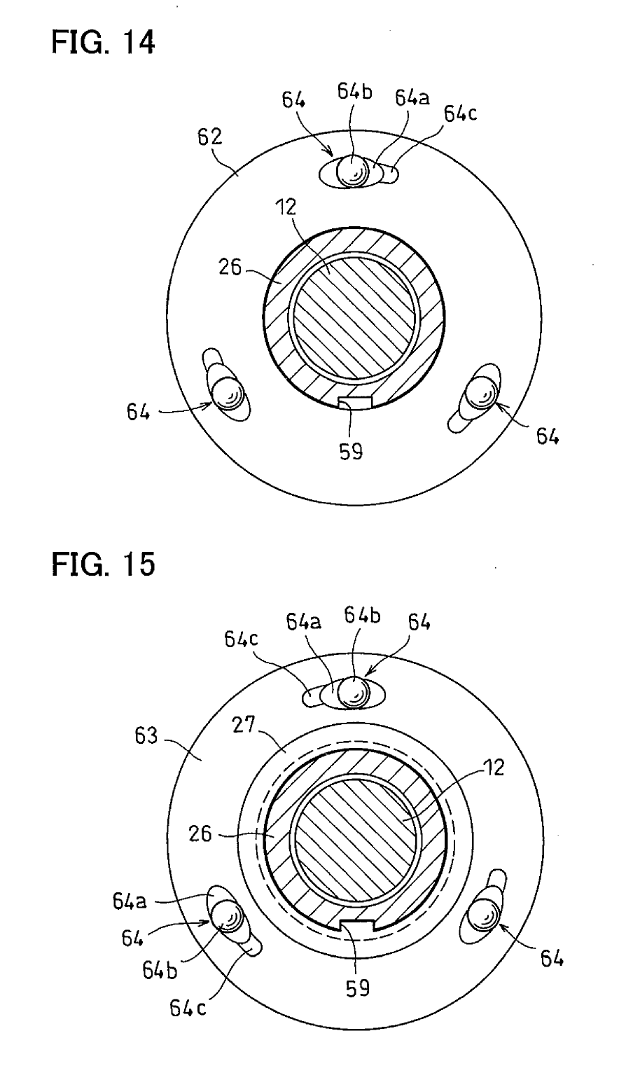

FIGS. 11-15 and FIG. 16 show different rotation-linear motion conversion mechanisms 50. The rotation-linear motion conversion mechanism 50 shown in FIGS. 11-15 includes first, second and third annular cam plates 61, 62 and 63 that are slidably fitted on the guide tube 26 of the clutch housing 14, in juxtaposition to each other in the axial direction. A cam mechanism 64 is disposed between the first cam plate 61 and the second cam plate 62, and configured to convert the relative rotation between the cam plates 61 and 62 to the relative axial linear motion therebetween, and another cam mechanism 64 is disposed between the second cam plate 62 and the third cam plate 63, and configured to convert the relative rotation between the cam plates 62 and 63 to the relative axial linear motion therebetween.

A thrust bearing 65 is mounted between the clutch housing 14 and the first cam plate 61, which is located remotest from the release bearing 30 among the three cam plates. The first cam plate 61 serves as an input member. That is, the rotation of the electric motor 41 is transmitted to the first cam plate 61. The third cam plate 63, which is closest to the release bearing 30, serves as an output member, and is connected to the outer race 31 of the release bearing 30 and a sleeve 27 which is non-rotatably but slidably supported by the guide tube 26.

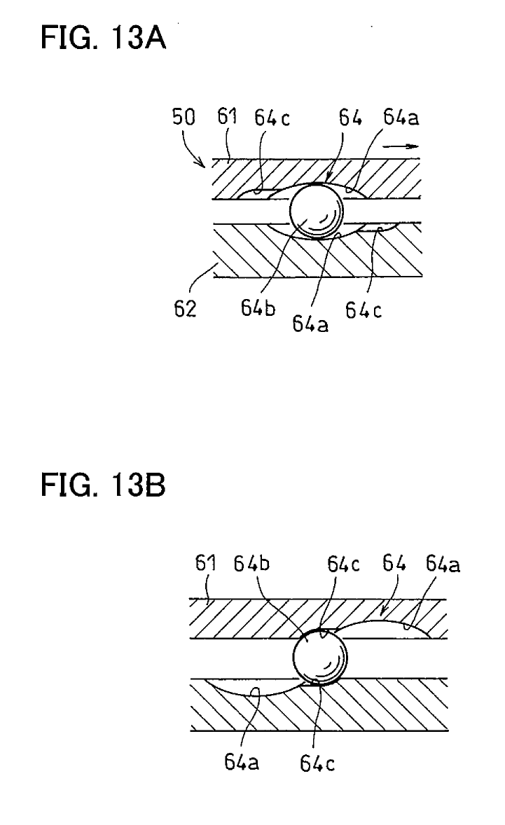

Referring to FIG. 13A, each of the cam mechanisms 64 is a ball cam constituted by pairs of cam grooves 64a which are the deepest at the circumferential center thereof, and gradually shallow toward the respective circumferential ends, and balls 64a each received between a corresponding pair of the cam grooves 64a.

Instead of such ball cams, face cams comprising V-shaped cam grooves and V-shaped cam protrusions may be used as the cam mechanisms 64.

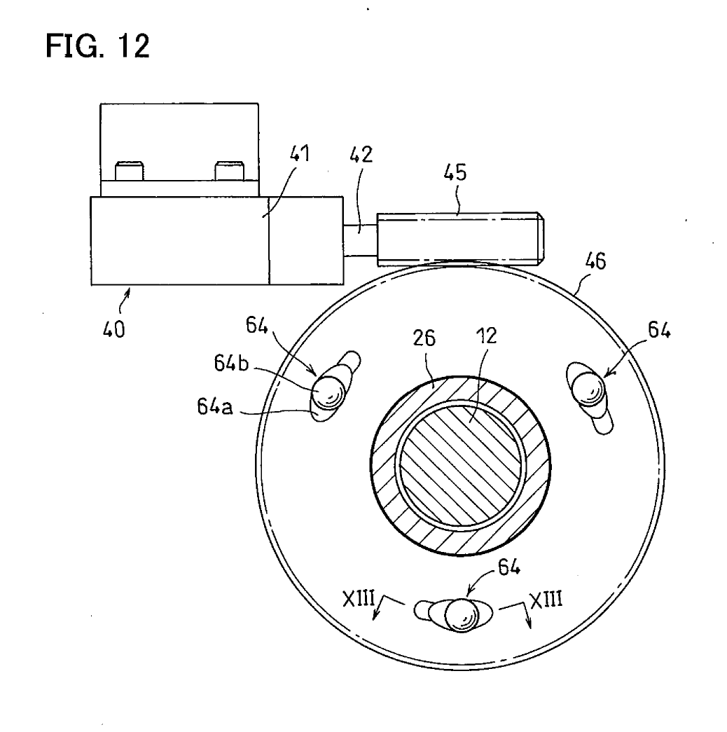

In FIGS. 11 and 12, the electric motor 41 includes a rotor 42 in the form of a solid shaft. In a similar manner to FIGS. 2 and 3, the rotor 42 of the electric motor 41 has attached thereto a worm 45 meshing with a worm wheel 46 on the outer periphery of the first cam plate 61 to rotate the first cam plate 61 with the electric motor 41.

With this rotation-linear motion conversion mechanism 50, when the first cam plate 61 is rotated by the electric motor 41, the ball cam 64 between the first cam plate 61 and the second cam plate 62 causes the second cam plate 62 to be moved axially while rotating to the position shown in FIG. 13B, while the ball cam 64 between the second cam plate 62 and the third cam plate 63 causes the third cam plate 63 to be moved axially relative to the second cam plate 62. The third cam plate 63 thus axially presses and moves the release bearing 30.

In FIGS. 11 and 12, as in FIGS. 2 and 3, the electric motor 41 is arranged to extend perpendicular to the input shaft 12, and configured to rotate the first cam plate 61 through the worm 45 and the worm wheel 46. Alternatively, in a similar manner to FIG. 4A, the electric motor 41 may be arranged to extend parallel to the input shaft 12, and rotate the first cam plate 61 through the rotation transmission mechanism 44 comprising the spur gars 47 and 48. Further alternatively, the first cam plate 61 may be directly rotated by the hollow motor 41 shown in FIG. 5.

As shown in FIG. 13A, shallow grooves 64c having a constant depth over the entire area thereof may be formed at one circumferential end of one of each opposed pair of the cam grooves 64a and the opposite circumferential end of the other of the opposed pair of cam grooves 64a such that when the first cam plate 61 and the second cam plate 62 rotate relative to each other, and the second cam plate 62 and the third cam plate 63 rotate relative to each other, each ball 64b is, as shown in FIG. 13B, fitted and trapped between the corresponding pair of the shallow grooves 64c. This prevents the reaction force from the diaphragm spring 19 from causing the first cam plate 61 and second cam plate 62, as well as the second cam plate 62 and third cam plate 63, to rotate relative to each other back to their respective original positions.

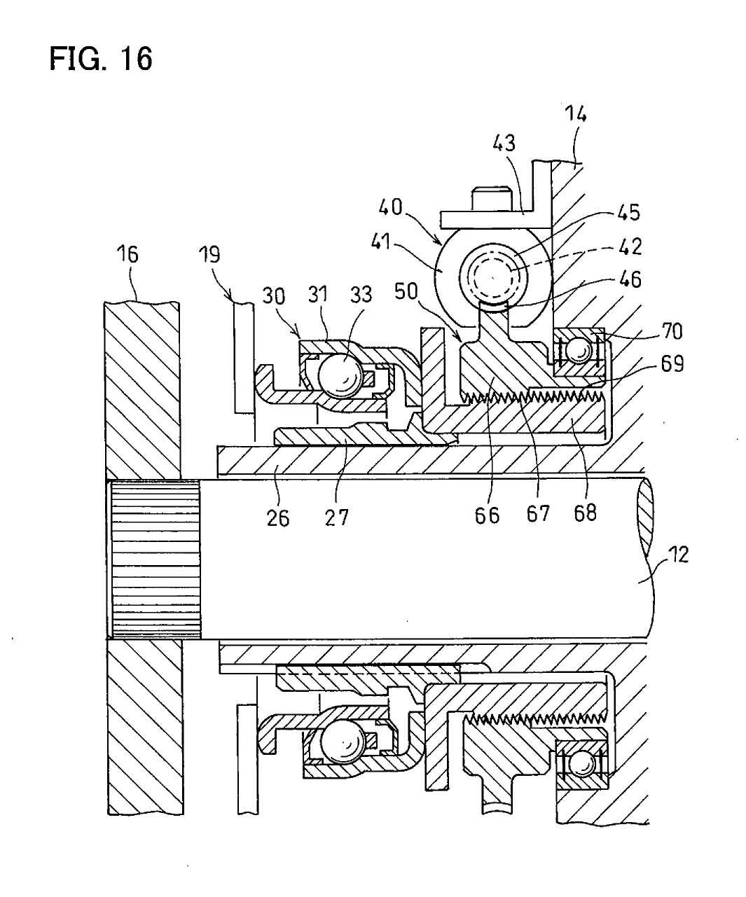

The rotation-linear motion conversion mechanism 50 shown in FIG. 16 includes a tubular nut member 66 having an inner periphery formed with an internal thread 67, and a tubular, externally threaded member 68 having an outer periphery formed with an external thread 69 in threaded engagement with the internal thread 67 of the nut member 66. The nut member 66 is rotatably supported by the clutch housing 14 through a rolling bearing 70, and is rotated by the electric motor 41. The externally threaded member 68 is connected to the sleeve 27 and outer race 31 of the release bearing 30.

The nut member 66 is rotated by the electric motor 42 through a worm 45 attached to the rotor 42 of the electric motor 41, and a worm wheel 46 formed on the outer periphery of the nut member 66 and meshing with the worm 45. When the nut member 66 rotates, due to the internal thread 67 being in threaded engagement with the external thread 69, the externally threaded member 68 moves axially, thus axially moving the release bearing 30.

In FIG. 16, as in FIGS. 2 and 3, the electric motor 41 is arranged to extend perpendicular to the input shaft 12, and configured to rotate the nut member 66 through the worm 45 and the worm wheel 46. Alternatively, in a similar manner to FIG. 4A, the electric motor 41 may be arranged to extend parallel to the input shaft 12, and rotate the nut member 66 through the rotation transmission mechanism 44 comprising the spur gars 47 and 48. Further alternatively, the nut member 66 may be directly rotated by the hollow motor 41 shown in FIG. 5.

### DESCRIPTION OF THE REFERENCE NUMERALS

10. Crankshaft
11. Transmission
12. Input shaft
13. Flywheel
16. Clutch disk
19. Diaphragm spring (pressure plate)
30. Release bearing
40. Axial force generating mechanism
41. Electric motor
42. Rotor
44. Rotation transmission mechanism
45. Worm
46. Worm wheel
47, 48. Spur gear
50. Rotation-linear motion conversion mechanism
51. Outer tube (tube)
52. Intermediate tube (tube)
53. Inner tube (tube)
54. Telescopic tube assembly
55, 56. Cam groove
57, 58. Pin
61. First cam plate
62. Second cam plate
63. Third cam plate
64. Cam mechanism (ball cam)
66. Nut member
67. Internal thread
68. Externally threaded member
69. External thread
70. Rolling bearing

1. An automatic clutch device comprising:
a flywheel attached to an end of a crankshaft of an engine;
a clutch disk provided at an end of an input shaft of a transmission, and opposed to the flywheel;
a pressure plate configured to bias the clutch disk toward the flywheel;
a release bearing configured to be movable toward and away from the pressure plate; and
an axial force generating mechanism configured to press and move the release bearing toward the pressure plate,
the automatic clutch device being configured such that when the pressure plate is pressed by the release bearing, the clutch disk and the pressure plate are disengaged from each other,
wherein the axial force generating mechanism comprises:
an electric motor disposed adjacent to an outer periphery of the end of the input shaft, and having a rotor; and
a rotation-linear motion conversion mechanism configured to convert rotation of the rotor of the electric motor to a linear motion of the release bearing.

2. The automatic clutch device of claim 1, wherein the electric motor comprises a hollow motor coaxial with the input shaft, the rotor being a tubular rotor, and wherein the axial force generating mechanism is configured such that the rotation of the rotor is directly transmitted to the rotation-linear motion conversion mechanism.

3. The automatic clutch device of claim 1, wherein the electric motor extends perpendicular to the input shaft, and the automatic clutch device further comprises a rotation transmission mechanism located between the rotor of the electric motor and the rotation-linear motion conversion mechanism, and comprising a worm and a worm wheel.

4. The automatic clutch device of claim 1, wherein the electric motor extends parallel to the input shaft, and the automatic clutch device further comprises a rotation transmission mechanism located between the rotor of the electric motor and the rotation-linear motion conversion mechanism, and comprising a pair of spur gears meshing with each other.

5. The automatic clutch device of claim 1,
wherein the rotation-linear motion conversion mechanism includes a plurality of tubes having different diameters from each other, and slidably fitted one in another such that the plurality of tubes form a telescopic tube assembly,
wherein a first one of each radially adjacent pair of the tubes is formed with an inclined cam groove, and a second one of the radially adjacent pair of tubes has a pin inserted in the cam groove, and
wherein one of the plurality of tubes which is largest in diameter is an input member configured such that the rotation of the rotor of the electric motor is transmitted to the input member, and one of the plurality of tubes which is smallest in diameter is an output member that is non-rotatably and slidably supported by a support member supporting the release bearing, and configured to press the release bearing.

6. The automatic clutch device of claim 1,
wherein the rotation-linear motion conversion mechanism includes a plurality of annular cam plates that are arranged in juxtaposition to each other in an axial direction,
wherein a cam mechanism is provided between each adjacent pair of the plurality of cam plates, and configured to convert relative rotation between the adjacent pair of cam plates to relative axial linear motion therebetween, and
wherein a first one of the plurality of cam plates remotest from the release bearing is an input member configured such that the rotation of the rotor of the electric motor is transmitted to the input member, and a second one of the plurality of cam plates closest to the release bearing is an output member that is non-rotatably and slidably supported by a support member supporting the release bearing, and configured to press the release bearing.

7. The automatic clutch device of claim 1,
wherein the rotation-linear motion conversion mechanism includes a tubular nut member having an inner periphery formed with an internal thread, and a tubular, externally threaded member in threaded engagement with the internal thread of the nut member, and
wherein the nut member (66) is an input member configured such that the rotation of the rotor of the electric motor is transmitted to the input member, and the externally threaded member is an output member that is non-rotatably and slidably supported by a support member (26) supporting the release bearing, and configured to press the release bearing.

8. The automatic clutch device of claim 2,
wherein the rotation-linear motion conversion mechanism includes a plurality of tubes having different diameters from each other, and slidably fitted one in another such that the plurality of tubes form a telescopic tube assembly,
wherein a first one of each radially adjacent pair of the tubes is formed with an inclined cam groove, and a second one of the radially adjacent pair of tubes has a pin inserted in the cam groove, and
wherein one of the plurality of tubes which is largest in diameter is an input member configured such that the rotation of the rotor of the electric motor is transmitted to the input member, and one of the plurality of tubes which is smallest in diameter is an output member that is non-rotatably and slidably supported by a support member supporting the release bearing, and configured to press the release bearing.

9. The automatic clutch device of claim 2,
wherein the rotation-linear motion conversion mechanism includes a plurality of annular cam plates that are arranged in juxtaposition to each other in an axial direction,
wherein a cam mechanism is provided between each adjacent pair of the plurality of cam plates, and configured to convert relative rotation between the adjacent pair of cam plates to relative axial linear motion therebetween, and
wherein a first one of the plurality of cam plates remotest from the release bearing is an input member configured such that the rotation of the rotor of the electric motor is transmitted to the input member, and a second one of the plurality of cam plates closest to the release bearing is an output member that is non-rotatably and slidably supported by a support member supporting the release bearing, and configured to press the release bearing.

10. The automatic clutch device of claim 2,
wherein the rotation-linear motion conversion mechanism includes a tubular nut member having an inner periphery formed with an internal thread, and a tubular, externally threaded member in threaded engagement with the internal thread of the nut member, and
wherein the nut member is an input member configured such that the rotation of the rotor of the electric motor is transmitted to the input member, and the externally threaded member is an output member that is non-rotatably and slidably supported by a support member supporting the release bearing, and configured to press the release bearing.

11. The automatic clutch device of claim 3,
wherein the rotation-linear motion conversion mechanism includes a plurality of tubes having different diameters from each other, and slidably fitted one in another such that the plurality of tubes form a telescopic tube assembly,
wherein a first one of each radially adjacent pair of the tubes is formed with an inclined cam groove, and a second one of the radially adjacent pair of tubes has a pin inserted in the cam groove, and
wherein one of the plurality of tubes which is largest in diameter is an input member configured such that the rotation of the rotor of the electric motor is transmitted to the input member, and one of the plurality of tubes which is smallest in diameter is an output member that is non-rotatably and slidably supported by a support member supporting the release bearing, and configured to press the release bearing.

12. The automatic clutch device of claim 3,
wherein the rotation-linear motion conversion mechanism includes a plurality of annular cam plates that are arranged in juxtaposition to each other in an axial direction,
wherein a cam mechanism is provided between each adjacent pair of the plurality of cam plates, and configured to convert relative rotation between the adjacent pair of cam plates to relative axial linear motion therebetween, and
wherein a first one of the plurality of cam plates remotest from the release bearing is an input member configured such that the rotation of the rotor of the electric motor is transmitted to the input member, and a second one of the plurality of cam plates closest to the release bearing is an output member that is non-rotatably and slidably supported by a support member supporting the release bearing, and configured to press the release bearing.

13. The automatic clutch device of claim 3,
wherein the rotation-linear motion conversion mechanism includes a tubular nut member having an inner periphery formed with an internal thread, and a tubular, externally threaded member in threaded engagement with the internal thread of the nut member, and
wherein the nut member is an input member configured such that the rotation of the rotor of the electric motor is transmitted to the input member, and the externally threaded member is an output member that is non-rotatably and slidably supported by a support member supporting the release bearing, and configured to press the release bearing.

14. The automatic clutch device of claim 4,
wherein the rotation-linear motion conversion mechanism includes a plurality of tubes having different diameters from each other, and slidably fitted one in another such that the plurality of tubes form a telescopic tube assembly,
wherein a first one of each radially adjacent pair of the tubes is formed with an inclined cam groove, and a second one of the radially adjacent pair of tubes has a pin inserted in the cam groove, and
wherein one of the plurality of tubes which is largest in diameter is an input member configured such that the rotation of the rotor of the electric motor is transmitted to the input member, and one of the plurality of tubes which is smallest in diameter is an output member that is non-rotatably and slidably supported by a support member supporting the release bearing, and configured to press the release bearing.

15. The automatic clutch device of claim 4,
wherein the rotation-linear motion conversion mechanism includes a plurality of annular cam plates that are arranged in juxtaposition to each other in an axial direction,
wherein a cam mechanism is provided between each adjacent pair of the plurality of cam plates, and configured to convert relative rotation between the adjacent pair of cam plates to relative axial linear motion therebetween, and
wherein a first one of the plurality of cam plates remotest from the release bearing is an input member configured such that the rotation of the rotor of the electric motor is transmitted to the input member, and a second one of the plurality of cam plates closest to the release bearing is an output member that is non-rotatably and slidably supported by a support member supporting the release bearing, and configured to press the release bearing.

16. The automatic clutch device of claim 4,
wherein the rotation-linear motion conversion mechanism includes a tubular nut member having an inner periphery formed with an internal thread, and a tubular, externally threaded member in threaded engagement with the internal thread of the nut member, and
wherein the nut member is an input member configured such that the rotation of the rotor of the electric motor is transmitted to the input member, and the externally threaded member is an output member that is non-rotatably and slidably supported by a support member supporting the release bearing, and configured to press the release bearing.
